(19) United States
(12) Patent Application Publication
(10) Pub. No.: US 2003/0161614 A1
(43) Pub. Date: Aug. 28, 2003

(54) Method and apparatus for playing back data recorded on a recoding medium

(75) Inventors: Masahide Yanagihara, Tokyo (JP); Seiichi Nakamura, Tokyo (JP); Hideki Sogabe, Tokyo (JP); Yasuhiro Ishibashi, Tokyo (JP)

Correspondence Address: FINNEGAN, HENDERSON, FARABOW, GARRETT & DUNNER, LLP, 1300 I STREET, NW, WASHINGTON, DC, 20005, US

(73) Assignee: Kabushiki Kaisha Toshiba

(21) Appl. No.: 10/348,753

(22) Filed: Jan. 23, 2003

Related U.S. Application Data
(62) Division of application No. 09/199,421, filed on Nov. 25, 1998.

(30) Foreign Application Priority Data
Nov. 28, 1997 (JP) 9-329217
May 22, 1998 (JP) 10-141214

(51) Int. Cl. H04N 5/781

(52) U.S. Cl. 386/95; 386/125

(57) ABSTRACT

Multimedia data embedded with control information for playback control are recorded on a recording medium in predetermined playback units. The recording medium also stores a management table, which manages a first file that defines the physical locations of the multimedia data and control information, and a second file that defines the physical locations of at least part of the multimedia data. A CPU executes playback control based on the first or second file by looking up the management table. Since a plurality of files that share multimedia data are used, the respective processes can be efficiently done without recording different versions of identical multimedia data.

### BACKGROUND OF THE INVENTION

The present invention relates to a data playback control apparatus, a recording medium used in the apparatus, a data playback control method, and image display apparatus and image switching display method.

In recent years, along with advance of multimedia techniques, a DVD has received a lot of attention as a new medium that takes the place of a CD-ROM. A DVD-ROM can record a large volume of data, i.e., 4.7 Gbytes on one side, and 9.4 Gbytes on two sides. Using this DVD-ROM, moving picture data such as a movie can be played back with high image quality.

As a playback apparatus using such DVD-ROM, a personal computer which includes a DVD-ROM drive as a standard component is used in addition to a consumer player.

The consumer player plays back only video using digital picture data recorded in a medium in accordance with the DVD video format. However, with the personal computer, not only video playback but also processing of, e.g., a game can be controlled using some picture data.

As described above, when the personal computer is used as a DVD-ROM player, various applications such as a game using some picture data and the like may be expected in addition to video playback according to the DVD video format, and such requirements are, in fact, increasing.

However, in order to implement such use method unique to the personal computer, a version of picture data dedicated to the personal computer recorded on a single medium together with picture data that can be played back by the consumer player. For this reason, such data waste the medium, and the data volume of the medium increases.

Hence, easy implementation of the use method unique to the personal computer without any large modification such as recording of more than one version of identical data on a single recording medium is required.

The data structure of video information recorded on a DVD-ROM medium is defined by the DVD video format. A video information stream is roughly classified into two types of data, i.e., presentation data and navigation data.

The presentation data is a set of video objects to be played back, and includes video, sub-picture, and audio data. The video data is compressed and encoded by MPEG2. Also, as an encoding method for the sub-picture and audio data, runlength coding, AC-3, and the like are supported. The sub-picture data is bitmap data, and is used for displaying a superimposed dialog of a movie, selection items on a menu window, and the like. One video object can contain video data for one channel, audio data for a maximum of eight channels, and sub-picture data for a maximum of 32 channels.

The navigation data is playback control data for controlling the playback sequence of the presentation data. Upon playing back a title, the playback order, playback method, and the like of moving picture data are determined by interpreting the navigation data, and moving picture data are played back according to them. Navigation commands can be embedded in the navigation data. The navigation commands are used for changing the playback contents and order of video data. Using the navigation commands, a title producer can define various branch structures in that title. With these structures, picture source switching functions, i.e., so-called multiangle, multistory, and the like can be implemented, and interactive titles can be produced.

However, in such conventional title structure, picture sources can only be switched at specific positions according to the DVD format. The picture source switching positions are determined by the embedding positions of navigation commands in a video stream upon producing the title.

Also, a picture source to be selected is limited to a specific one recorded on an identical DVD medium. Hence, control for linking DVD video to another arbitrary picture source such as picture data recorded on another medium, digital contents provided by the Internet, and the like cannot be made.

Recently, information distribution via the Internet is prevalent. As the Internet prevails, digital contents at any place on the globe can be easily acquired and viewed. From such environment, production of new contents as a combination of a DVD video title and the Internet technique is sought for.

Hence, to allow title playback with higher degree of freedom, implementation of switching of a playback image at an arbitrary playback position of a moving picture stream that forms a title, link to an arbitrary picture source, automatic updating of the picture source at a link destination, and the like without changing the title structure of a video title is desired.

### BRIEF SUMMARY OF THE INVENTION

Accordingly, it is an object of the present invention to provide a data playback control apparatus which can easily implement a use method unique to a personal computer without requiring any large modification such as repetitive recording of identical data on a single recording medium, a recording medium used in the apparatus, and a data playback control method.

It is another object of the present invention to provide an image display apparatus which can implement switching of a playback image at an arbitrary playback position of a moving picture stream that forms a title, link to an arbitrary picture source, automatic updating of the picture source at a link destination, and the like without changing the title structure of a video title, so as to allow title playback with higher degree of freedom, and an image switching display method applied to the apparatus.

According to one aspect of the present invention, there is provided a data playback control apparatus for playing back multimedia data recorded on a recording medium on the basis of the multimedia data and control information for playback control embedded in the multimedia data, comprising a management table for managing a first file that defines physical locations of the multimedia data and control information, and a second file that defines physical locations of at least part of the multimedia data, and control means for controlling playback of the multimedia data on the basis of one of the first and second files stored in the management table.

According to another aspect of the present invention, there is provided a recording medium storing computer-readable information, the information comprising multimedia data embedded with control information for playback control in predetermined playback units, and a management table for managing a first file that defines physical locations of the multimedia data and control information, and a second file that defines physical locations of at least part of the multimedia data.

According to still another aspect of the present invention, there is provided a data playback control method for use in a data playback control apparatus for playing back multimedia data recorded on a recording medium on the basis of the multimedia data and control information for playback control embedded in the multimedia data, comprising the steps of preparing a management table for managing a first file that defines physical locations of the multimedia data and control information, and a second file that defines physical locations of at least part of the multimedia data, and executing playback of the multimedia data on the basis of one of the first and second files stored in the management table.

According to still another aspect of the present invention, there is provided a data playback control apparatus for playing back multimedia data recorded on a recording medium on the basis of the multimedia data and control information for playback control embedded in the multimedia data, comprising an information table defining processing corresponding to user actions in units of playback times of the multimedia data, user action detection means for detecting presence/absence of a user action during playback of the multimedia data, and control means for looking up the information table when the user action detection means detects that a user action has been taken, and executing processing corresponding to the user action defined by the playback time of the multimedia data at that time.

According to still another aspect of the present invention, there is provided a data playback control apparatus for playing back multimedia data recorded on a recording medium on the basis of the multimedia data and control information for playback control embedded in the multimedia data, comprising an information table defining processing corresponding to user actions in units of playback volumes of the multimedia data, user action detection means for detecting presence/absence of a user action during playback of the multimedia data, and control means for looking up the information table when the user action detection means detects that a user action has been taken, and executing processing corresponding to the user action defined by the playback volume of the multimedia data at that time.

According to still another aspect of the present invention, there is provided a recording medium storing computer-readable information, the information comprising multimedia data embedded with control information for playback control in predetermined playback units, and an information table defining processing corresponding to user actions in playback time units of the multimedia data.

According to still another aspect of the present invention, there is provided a recording medium storing computer-readable information, the information comprising multimedia data embedded with control information for playback control in predetermined playback units, and an information table defining processing corresponding to user actions in units of playback volumes of the multimedia data.

According to still another aspect of the present invention, there is provided a data playback control method for use in a data playback control apparatus for playing back multimedia data recorded on a recording medium on the basis of the multimedia data and control information for playback control embedded in the multimedia data, comprising the steps of preparing an information table defining processing corresponding to user actions in playback time units of the multimedia data, detecting presence/absence of a user action during playback of the multimedia data, and looking up the information table when it is detected that a user action has been taken, and executing processing corresponding to the user action defined by the playback time of the multimedia data at that time.

According to still another aspect of the present invention, there is provided a data playback control method for use in a data playback control apparatus for playing back multimedia data recorded on a recording medium on the basis of the multimedia data and control information for playback control embedded in the multimedia data, comprising the steps of preparing an information table defining processing corresponding to user actions in units of playback volumes of the multimedia data, detecting presence/absence of a user action during playback of the multimedia data, and looking up the information table when it is detected that a user action has been taken, and executing processing corresponding to the user action defined by the playback volume of the multimedia data at that time.

According to still another aspect of the present invention, there is provided a data playback control apparatus for playing back multimedia data stored in a recording medium on the basis of the multimedia data, and first control information for playback control embedded in the multimedia data, comprising control information acquisition means for acquiring second control information for controlling at least part of the multimedia data in addition to the first control information embedded in the multimedia data, and control means for performing playback control of the multimedia data on the basis of the second control information acquired by the control information acquisition means.

According to still another aspect of the present invention, there is provided a recording medium storing computer-readable information, the information comprising multimedia data embedded with first control information for playback control in predetermined playback units, and second control information for controlling at least part of the multimedia data in addition to the first control information embedded in the multimedia data.

According to still another aspect of the present invention, there is provided a data playback control method for use in a data playback control apparatus for playing back multimedia data stored in a recording medium on the basis of the multimedia data, and first control information for playback control embedded in the multimedia data, comprising the steps of acquiring second control information for controlling at least part of the multimedia data in addition to the first control information embedded in the multimedia data, and performing playback control of the multimedia data on the basis of the second control information.

According to still another aspect of the present invention, there is provided an image display apparatus comprising playback means for reading out and playing back a moving picture stream from a recording medium that stores link information designating a link image to be inserted into the moving picture stream, and playback image switching means for counting a time elapsed from the beginning of playback of the moving picture stream, and switching an image to be played back from the moving picture stream to the link image designated by the link information when the time elapsed from the beginning of playback has reached a link image insertion time which is set in advance.

According to still another aspect of the present invention, there is provided an image display apparatus comprising playback means for playing back a moving picture stream, means for counting a time elapsed from the beginning of playback of the moving picture stream, and generating an interrupt signal when the time elapsed from the beginning of playback of the moving picture stream has reached a link image insertion time which is set in advance, and moving picture playback control program means for controlling the playback means to switch an image to be played back from the moving picture stream to a link image other than the moving picture stream in response to the interrupt signal.

According to still another aspect of the present invention, there is provided an image switching display method applied to an image display apparatus for reading out and playing back a moving picture stream stored in a recording medium, comprising the steps of holding a predetermined elapsed time from the beginning of playback of the moving picture stream as a link image insertion time, and switching an image to be played back from the moving picture stream to a link image other than the moving picture stream when a time elapsed from the beginning of playback of the moving picture stream has reached the link image insertion time.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention in which:

FIG. 1 is a block diagram showing the arrangement of a data playback control apparatus according to the first embodiment of the present invention;

FIG. 2 is a schematic perspective view showing the outer appearance of a personal computer that implements the data playback control apparatus of the first embodiment;

FIGS. 3A and 3B are views for explaining a management table and file structure stored in a recording medium of the first embodiment;

FIG. 4 is a view for explaining the file structure of the recording medium of the first embodiment;

FIG. 5 shows a window for making the user to select a playback mode in the first embodiment;

FIG. 6 shows a window displayed during game playback in the first embodiment;

FIG. 7 is a flow chart showing the data playback process in the first embodiment;

FIG. 8 is a flow chart showing the game playback process in the first embodiment;

FIG. 9 is a view for explaining a playback control method in given time units according to the second embodiment of the present invention;

FIG. 10 is a flow chart showing the data playback process in the second embodiment;

FIG. 11 is a view for explaining a method of setting command sets in the third embodiment of the present invention;

FIG. 12 is a flow chart showing the data playback process in the third embodiment;

FIG. 13 is a block diagram showing the basic hardware and software arrangements that implement an image display apparatus according to the fourth embodiment of the present invention;

FIG. 14 is a diagram showing an example of the hardware arrangement of a time set register and time counter in the image display apparatus of the fourth embodiment;

FIGS. 15A and 15B are views for explaining switching between the DVD video and link image in the image display apparatus of the fourth embodiment;

FIG. 16 is a chart showing the playback image switching process in the image display apparatus of the fourth embodiment;

FIG. 17 is a block diagram showing an example of the hardware arrangement of the image display apparatus of the fourth embodiment in detail;

FIG. 18 shows the format of video data used in the image display apparatus of the fourth embodiment;

FIGS. 19A to 19D are views for explaining switching between the DVD video and link image in the image display apparatus of the fourth embodiment;

FIG. 20 shows the switching state between the DVD video and link image in the image display apparatus of the fourth embodiment;

FIG. 21 is a flow chart showing the operation of a DVD playback control program in the image display apparatus of the fourth embodiment; and

FIG. 22 is a flow chart showing the operation of a DVD decoder in the image display apparatus of the fourth embodiment.

### DETAILED DESCRIPTION OF THE INVENTION

The preferred embodiments of the present invention will be described hereinafter with reference to the accompanying drawings.

<First Embodiment>

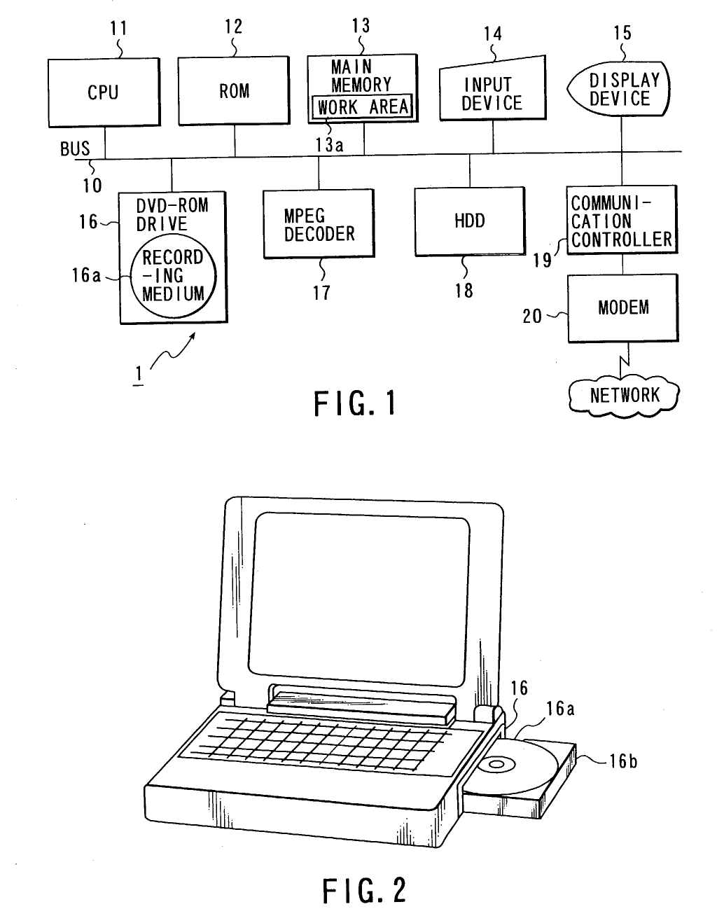

FIG. 1 is a block diagram showing the arrangement of a data playback control apparatus according to the first embodiment of the present invention. Note that this apparatus is implemented by a personal computer that includes a DVD-ROM drive as a standard component.

This apparatus can process data such as AV data including picture data, audio data, and the like, broadcast data, and so forth, which can be continuously played back (such data will be referred to as multimedia data hereinafter). In this embodiment, processing of picture data will be exemplified for the sake of simplicity.

As shown in FIG. 1, a data playback apparatus 1 includes a CPU 11. The CPU 11 controls the overall apparatus, and mainly performs data playback control for a DVD-ROM drive 16 in this embodiment. The CPU 11 is connected to a ROM 12, main memory 13, input device 14, display device 15, DVD-ROM drive 16, MPEG decoder 17, HDD (hard disk device) 18, communication controller 19, and the like via a system bus 10.

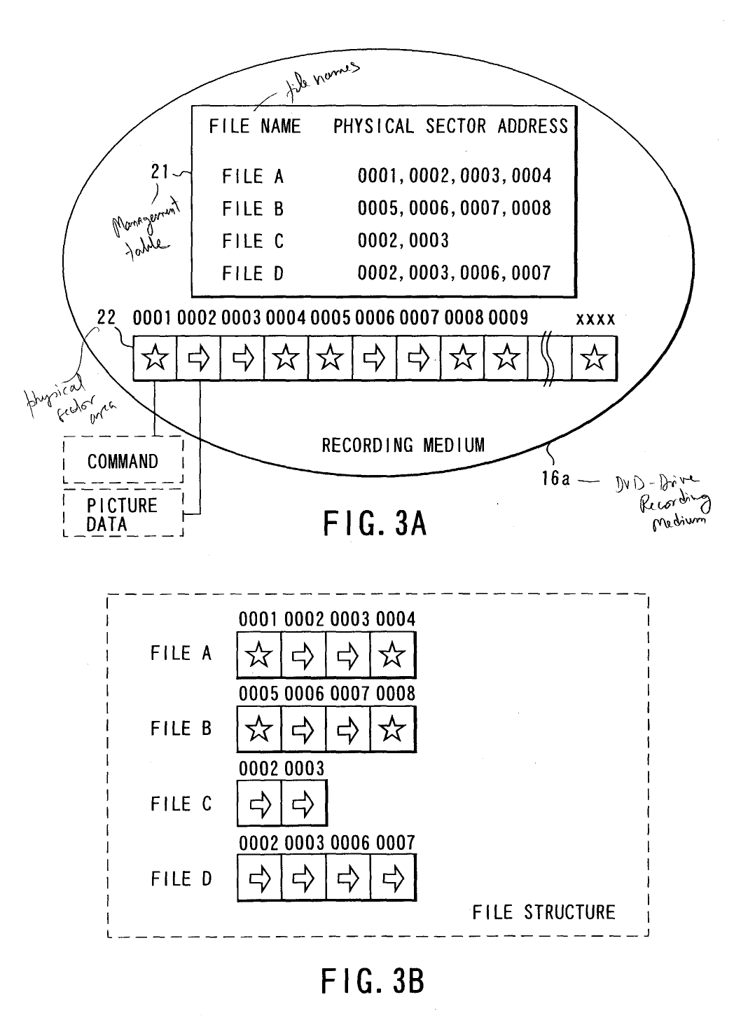

The ROM 12 stores various programs executed by the CPU 11 and data. The main memory 13 includes, e.g., a DRAM, which stores various kinds of data required for the processing of the CPU 11. The main memory 13 is allocated with a work area 13a, which stores a management table 21 (see FIG. 3A) read out from a recording medium 16a in the DVD-ROM drive 16, and the like. Note that the management table 21 will be described later with reference to FIGS. 3A and 3B.

The input device 14 includes a pointing device such as a mouse, accupoint, or the like in addition to a keyboard, and is used for inputting data and instructing functions. The display device 15 includes, e.g., a TFT color liquid crystal display, and is used for displaying data.

The DVD-ROM drive 16 is equipped in this apparatus as a standard component, and reads out data recorded on a physical sector area 22 of the recording medium 16a at a transfer rate of 10.08 Mbps (maximum) under the control of the CPU 11. The DVD-ROM drive 16 is comprised of a motor, pickup, pickup drive, servo controller, drive controller including an ECC circuit for error detection/correction, and the like in addition to the recording medium 16a as an optical disk.

The recording medium 16a has a capacity capable of recording a movie of approximately 135 min on one side, and is set in the DVD-ROM drive 16. In this embodiment, digital picture data (color moving picture data), which is compressed and encoded by MPEG, is recorded on the recording medium 16a. Furthermore, in this embodiment, an application program executed when the picture data is used for, e.g., a game and the like are stored in this recording medium 16a in addition to the management table 21 (see FIG. 3A) for controlling playback of the digital video data, as will be described later.

The MPEG decoder 17 decodes the digital picture data played back from the recording medium 16a. The MPEG decoder 17 can be implemented by either hardware or software.

The HDD 18 is used as an external storage device, and stores various data such as various kinds of files, application programs (including a WWW browser), and the like that can be used in this apparatus. The communication controller 19 controls data communications with an external apparatus via a modem 20. The modem 20 is a signal converter for transmitting/receiving data to/from an external apparatus via a telephone line or the like, and has a data modulation/demodulation function.

FIG. 2 is a schematic perspective view showing the outer appearance of a personal computer which has a DVD-ROM drive as a standard component, which implements the data playback apparatus.

The personal computer according to this embodiment has the DVD-ROM drive 16, as shown in FIG. 2. The DVD-ROM drive 16 has a tray 16b which slides horizontally in response to user's operation. The recording medium 16a is placed on this tray 16a, is loaded into the main body of the DVD-ROM drive 16, and is driven by the DVD-ROM drive 16.

The file structure of the recording medium 16a will be explained below.

FIGS. 3A and 3B are views for explaining the management table and file structure stored in the recording medium 16a in the first embodiment.

As shown in FIG. 3A, the management table 21 and physical sector area 22 are assured on the recording medium 16a.

The management table 21 stores file names and corresponding physical sector addresses in units of files. The physical sector area 22 records a series of digital picture data (presentation data) used for DVD-Video, and control commands embedded in the digital picture data in predetermined playback units.

The control commands are used for controlling playback of the digital picture data to couple picture data into one scene, to determine a scene to be reached by jump in response to a user action upon depression of, e.g., a button, and so forth, and are called navigation commands (or navigation data). With these control commands, video playback can be made in a predetermined playback order.

Assuming that a game is played by using some digital picture data in the personal computer, new data dedicated to that game must be prepared by removing the control commands from video data consisting of picture data and control commands, and must be recorded on the recording medium 16a. In such case, two different versions of data having identical picture data are recorded, resulting in a very large data volume.

In order to solve such problem, this embodiment has a version when identical video data is viewed from a consumer player and that when it is viewed from the personal computer as different files, as shown in FIG. 3B.

That is, Files A and B correspond to the versions when viewed from the consumer player, and both control commands and picture data form a single file. File A defines the physical locations of picture data and control commands recorded at physical sector addresses “0001” to “0004”. File B defines the physical locations of picture data and control commands recorded at physical sector addresses “0005” to “0008”. These Files A and B are used in normal video playback.

By contrast, Files C and D correspond to the version when viewed from the personal computer, and a single file is formed by coupling picture data portions. For example, File C defines the physical locations of picture data recorded at physical sector addresses “0002” and “0003”. File D defines the physical location of picture data recorded at physical sector addresses “0002”, “0003”, “0006”, and “0007”. These Files C and D are used in, e.g., a game that uses picture data alone.

Note that picture data to be used can be selected arbitrarily. For example, picture data recorded at physical sector addresses “0002” and “0006” may be used in, e.g., a game.

The management table 21 manages a plurality of files that share such digital picture data, and stores the file names and corresponding physical sector addresses in units of files. The management table 21 is recorded in a predetermined sector on the recording medium 16a according to the “ISO9660” format as the standard format, and is loaded onto the work area 13a of the main memory 13 upon playback. The CPU 11 executes data playback (to be described later) by looking up the management table 21 loaded onto the work area 13a.

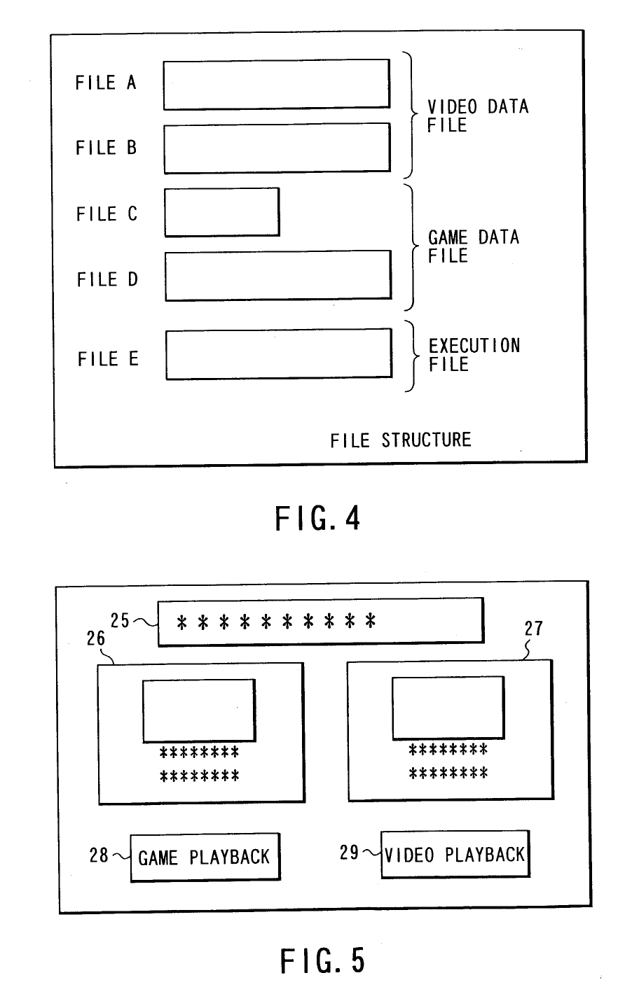

Note that the recording medium 16a also records File E as an execution file (an application program for a game) used upon game playback, in addition to Files A to D as data files. This state is shown in FIG. 4. File E as the execution file is an application program provided in correspondence with Files C and D as the picture data file for a game. This application program executes all the processes required for the game, for example, receives user's inputs, displays a game window, and so forth.

The display device 15 displays a window for making the user to select the playback mode before playback, as shown in FIG. 5. A title 25 is displayed on the top of the window, a game comment (graphics and text) 26 and video comment (graphics and text) 27 are displayed on the central portion, and a selection button 28 for game playback and selection button 29 for video playback are displayed on the bottom portion. Upon displaying this selection window, the user can select one of video playback and game playback using the input device 14.

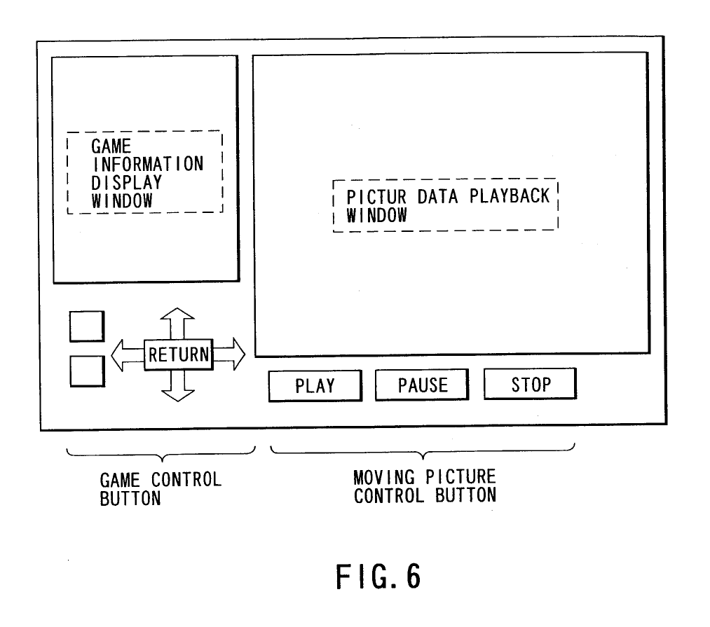

During game playback, a window shown in FIG. 6 is displayed. A game information display window and picture data playback window are displayed on the left and right central portion of the window, and game control buttons and moving picture control buttons are displayed on the bottom portion. While the user plays the game, he or she operates the game control buttons on the basis of the contents on the left game information display window. Also, the user operates the moving picture control buttons to control playback, pause, and the like of picture data.

The processing of the first embodiment will be explained below.

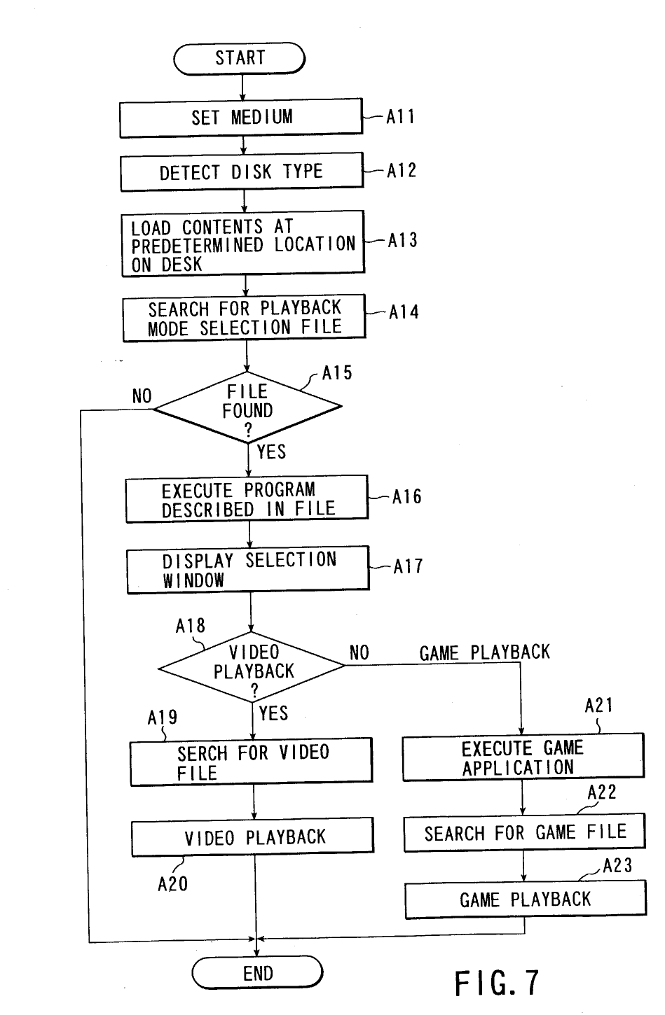

FIG. 7 is a flow chart showing the data playback process in the first embodiment.

Upon data playback, the recording medium 16a is set in the DVD-ROM drive 16 (step A11).

Note that the recording medium 16a records a playback mode selection file (e.g., a file based on an auto-run function of Windows® 95) according to the “ISO9660” format in a predetermined sector. In the following description, two playback modes, e.g., video and game playback modes are assumed for the sake of simplicity.

When the recording medium 16a is set in the DVD-ROM 16, the CPU 11 detects the type of recording medium 16a via a disk manager or the like (step A12). If that recording medium 16a is a DVD-ROM, the contents of the management table 21 located at a predetermined location on the recording medium 16a are loaded onto the work area 13a of the main memory 13 (step A13). In this manner, the CPU 11 can look up the management table 21 via the work area 13a.

The CPU 11 starts the DVD-ROM drive 16 and searches for a playback mode selection file recorded on the recording medium 16a (step A14). If the playback mode selection file is found (Yes in step A15), the CPU 11 executes a program described in that file (step A16) to display the window (FIG. 5) for making the user select the playback mode on the display device 15 (step A17).

Upon display of this selection window, the user selects one of the video and game playback modes using the input device 14. If the video playback mode is selected (Yes in step A18), the CPU 11 looks up the management table 21 shown in FIG. 3A to search it for video playback files (step A19). The video/game playback files are distinguished from each other by their file names. In the example shown in FIG. 3A, Files A and B are obtained by search.

After the video playback files are obtained, the CPU 11 confirms the physical locations (sector addresses on the medium) of digital picture data and control commands on the basis of the obtained video playback files, issues a read request to the DVD-ROM drive 16, and reads out these data from the recording medium 16a, thus executing video playback (step A20).

On the other hand, if the game playback mode is selected (Yes in step A18), the CPU 11 executes an application program (File E in FIG. 5) for the game first (step A21).

Subsequently, the CPU 11 looks up the management table 21 shown in FIG. 3A to search it for game playback files (step A22). In the example shown in FIG. 3A, Files C and D are obtained by search. After the game playback files are obtained, the CPU 11 confirms the physical locations (sector addresses on the medium) of picture data used in that game on the basis of the obtained game playback files, issues a read request to the DVD-ROM drive 16, and reads out these data from the recording medium 16a, thus executing game playback (step A23).

The game playback in step A23 above will be described in detail below.

Note that the game playback can be done by either the game application program itself or another playback software. As playback software that can be used, operation playback software called Media Player, which runs on Windows® 95 of Microsoft Corp., and operation playback software called Active Movie Control are available. When such playback software is used, the game application program controls the overall game, and sends picture data to playback software (Media Player or the like) to play them back. The operation when Media Player is used as playback software will be explained below.

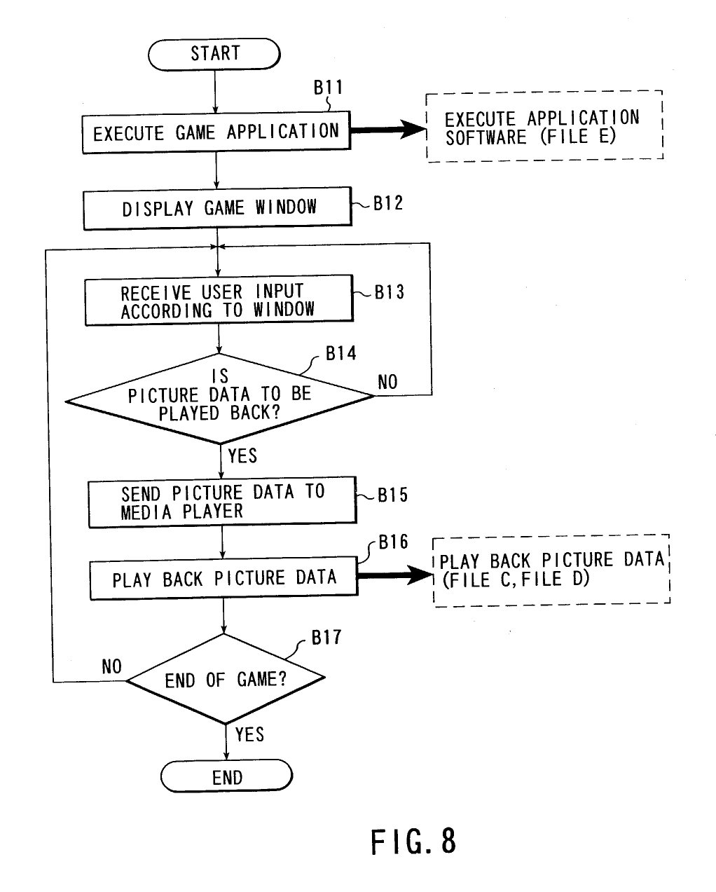

FIG. 8 is a flow chart showing the game playback process in detail.

The CPU 11 executes the game application program (step B11). More specifically, in this embodiment, File E on the recording medium 16a is read out and is executed. As a result, the game window is displayed on the display device 15 to start the game (step B12).

The user makes inputs while observing the display window during the game (step B13). The game application program checks if picture data are to be played back (step B14). If picture data are not played back (No in step B14), the flow returns to step B13.

On the other hand, if picture data are to be played back (Yes in step B14), the game application program sends the picture data to Media Player as another playback software (step B15). Media Player plays back the picture data (step B16). That is, in this embodiment, Files C and D on the recording medium 16a are read out and played back.

The game application program checks if the game is to end (step B17). If the game does not end (No in step B17), the flow returns to step B13; otherwise (Yes in step B17), the game ends.

As described above, in this embodiment, since playback is made using the management table that manages a plurality of files which share digital picture data recorded on the recording medium 16a, a use method unique to the personal computer can be easily implemented without requiring any large modification such as recording of different versions of identical data.

In this embodiment, the user selects the playback mode (video/game playback mode). Alternatively, for example, when the game application program is designated, the game playback mode is selected; otherwise, the video playback mode is selected to execute playback.

<Second Embodiment>

The second embodiment of the present invention will be described below.

A consumer player can only control digital picture data recorded on a DVD-ROM in physical units. That is, the consumer player can only play back a series of digital picture data in the predetermined playback order on the basis of control commands embedded in the digital picture data in predetermined playback units.

Note that a personal computer can acquire every kinds of worldwide information via the Internet using, e.g., a WWW browser, and such combination of the Internet and DVD-ROM is demanded. More specifically, when a picture scene of a given product is displayed during data playback, the information pertaining to that product is acquired via the Internet, and is provided to the user.

Such use demand upon data playback is not limited to the combination with the Internet. For example, the following use method is demanded. That is, when a picture scene of a given animal is displayed during data playback, another digital picture data of that animal is played back.

The second embodiment implements such use method during data playback and is especially characterized by defining flexible actions in given time units using a time information table.

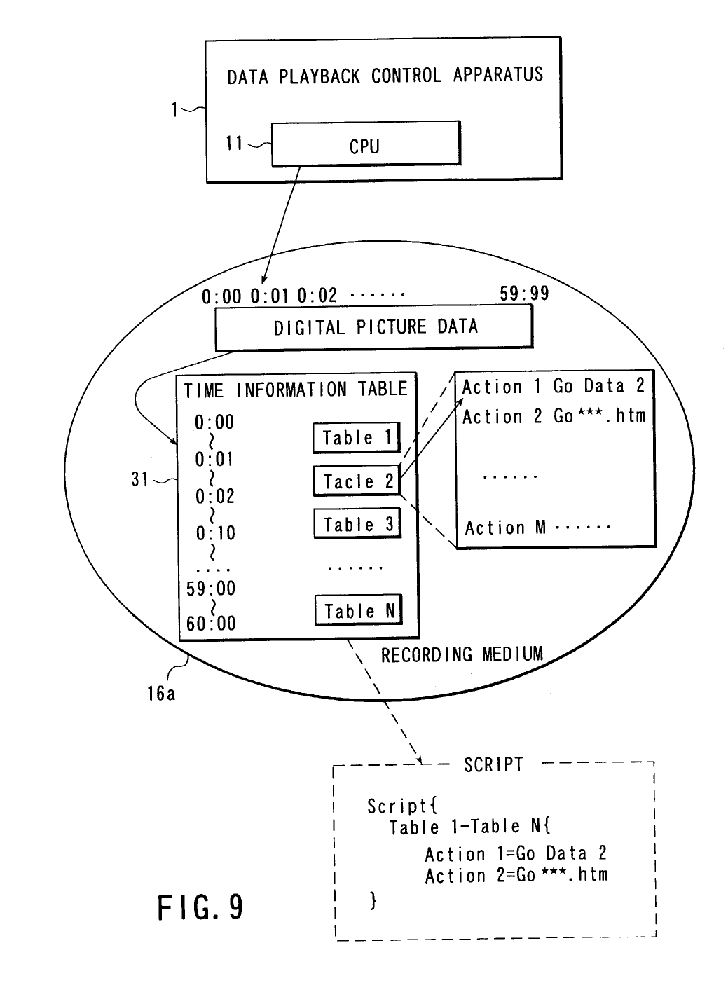

FIG. 9 is a view for explaining the playback control method in given time units in the second embodiment. The respective sectors of the recording medium 16a record a series of digital picture data used in DVD-Video and control commands embedded in these digital picture data in predetermined playback units.

In this embodiment, a time information table 31 that defines processing contents corresponding to user actions in given time units with respect to the digital picture data recorded on the recording medium 16a is prepared. In the example shown in FIG. 9, a picture scene for 60 min is segmented in units of seconds, and Tables are assigned to these segments; Table1 for “0:00 to 0:01”, Table2 for “0:01 to 0:02”, Table3 for “0:02 to 0:10”, . . . , TableN for “59:00 to “60:00”. These tables define processing contents corresponding to user actions.

The CPU 11 in the data playback control apparatus 1 uses such time information table 31. When a user action is taken during playback of digital picture data recorded on the recording medium 16a, the CPU 11 looks up the time information table 31 on the basis of the playback time at that time and executes processing corresponding to that user action.

For example, when a command for taking Action1 is issued during the interval “0:01 to “0:02”, the CPU 11 looks up Table1 and executes processing for starting playback of another digital picture data 2. At the same time, when a command for taking Action2 is issued, the CPU 11 executes processing for searching Internet information by starting a WWW browser. In this case, Table1 defines information of the Internet connection destination such as a URL or the like.

Note that this time information table 31 is recorded on a predetermined sector of the recording medium 16a in accordance with the “ISO9660” format as the standard format, and is loaded onto the work area 13a of the main memory 13 upon playback. The CPU 11 in the data playback control apparatus 1 looks up the time information table 31 loaded on the work area 13a and makes the aforementioned playback control in units of time.

The processing operation of the second embodiment will be explained below.

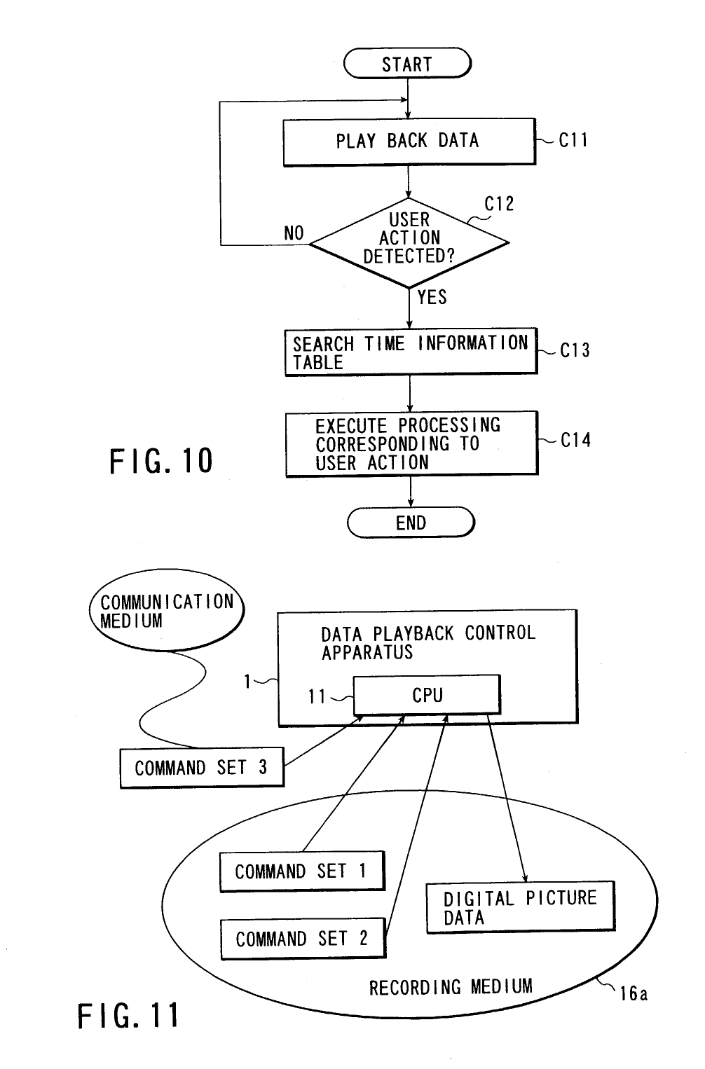

FIG. 10 is a flow chart showing the data playback process in the second embodiment. During data playback (video or game playback mode) (step C11), the CPU 11 detects the presence/absence of a user action upon depression of, e.g., a button (step C12).

If it is detected via the input device 14 that a user action has been taken (Yes in step C12), the CPU 11 looks up the time information table 31 shown in FIG. 9 to determine the processing contents corresponding to the current playback time (a time period from the beginning of playback to the timing the user action has been taken) (step C13).

Note that the time information table 31 is located at a predetermined location on the recording medium 16a. In this embodiment, the table 31 is loaded from the recording medium 16a onto the work area 13a upon playback so as to cache the table. Hence, the CPU 11 looks up the time information table 31 via the work area 13a.

When the processing contents corresponding to the current playback time are determined, the CPU 11 executes processing corresponding to the user action in the processing contents (step C14). More specifically, in the example shown in FIG. 9, when Action1 is taken during the interval “0:01 to 0:02”, the CPU 11 begins to play back another digital picture data 2 with reference to Table1. Assume that this digital picture data 2 is pre-recorded on the recording medium 16a.

When Action2 is taken at the same time, the CPU 11 starts the WWW browser and searches Internet information. More specifically, the CPU 11 connects a server on the Internet via the modem 20 under the control of the communication controller 19, acquires Internet information designated in advance via the server, displays it on the display device 15, and so forth.

In this manner, since the playback control of digital picture data is made in given time units, another processing corresponding to a user action can be immediately executed during data playback. With this control, the user can see the Internet information, another digital picture data, and the like during data playback.

In this embodiment, the aforementioned processing is achieved using the time information table 31 recorded on the recording medium 16a. Alternatively, information in this time information table 31 may be externally described in a script format. FIG. 9 also shows a description example of the script format at that time. When the contents of the table are described in a given language in the script format, tables need not be prepared in given time units, and the data volume can be reduced.

In this embodiment, processing corresponding to a user action is executed on the basis of the playback time during data playback. However, the present invention is not limited to such time management. For example, similar processing may be implemented by managing the playback volume (the data volume from the beginning of playback) of data. In such case, information tables that define processing contents in units of playback volumes are prepared in the recording medium 16a, and when a user action has been taken, the pre-defined processing is executed on the basis of the playback volume at that time. Furthermore, the contents defined by these information tables may be described in a given language in the script format.

Furthermore, similar processing may be attained by acquiring such information tables from an external source (e.g., a communication medium or an external storage device such as an HDD).

<Third Embodiment>

The third embodiment of the present invention will be described below.

In a consumer player, since a command set (control command group) for digital picture data is fixed, playback control can be made in only one way. This is because the consumer player need only playback a series of digital picture data in a predetermined playback order, and need not make different kinds of playback control. On the other hand, a personal computer is required to make various kinds of playback control, e.g., to arbitrarily change the playback order, to partially play back picture data, and so forth, in addition to the fixed playback control.

To meet such requirements, the third embodiment is characterized in that a plurality of command sets (control command groups) are set in addition to a control command group already present in digital picture data, and playback control of digital picture data is made using these command sets.

FIG. 11 is a view for explaining the method of setting command sets in the third embodiment. The respective sectors of the recording medium 16a record a series of digital picture data used in DVD-Video, and control command embedded in the digital picture data in predetermined playback units.

In this embodiment, a plurality of command sets such as command set 1, command set 2, and the like for identical digital picture data are prepared in a file format, in addition to the control commands in the digital picture data.

These command sets 1 and 2 are used for playback control using the personal computer. In this embodiment, assume that command set 1 has the same control contents as those for the consumer player, and command set 2 has control contents different from those for the consumer player.

These command sets 1 and 2 are recorded on predetermined sectors of the recording medium 16a in accordance with the “ISO9660” format as the standard format, and are loaded onto the work area 13a of the main memory 13 upon playback. The CPU 11 refers to command sets 1 and 2 loaded onto the work area 13a, and executes playback control defined by each command set.

Also, command set 3 may be acquired from an external source such as a communication medium, external storage device, or the like, and playback control may be made on the basis of that command set 3. In this embodiment, assume that command set 3 is acquired from a communication medium, and has control contents different from those for the consumer player.

The processing operation of the third embodiment will be explained below.

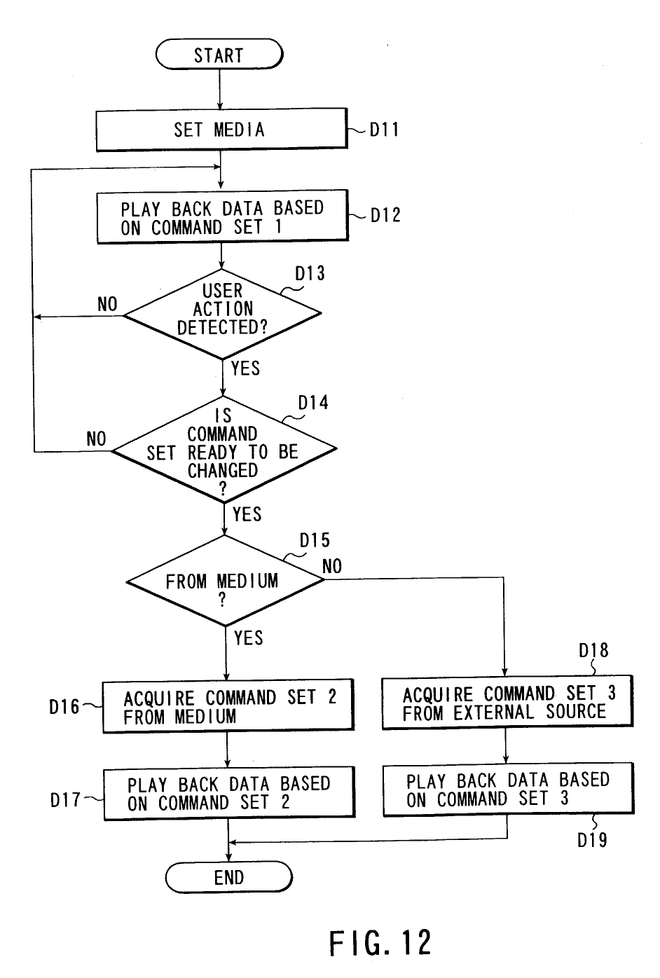

FIG. 12 is a flow chart showing the data playback process in the third embodiment. Upon data playback, the recording medium 16a is set in the DVD-ROM drive 16 (step D11).

Assume that command set 1 is set as a default. The CPU 11 reads out command set 1 from the recording medium 16a by starting the DVD-ROM drive 16, stores it on the work area 13a of the memory 13, and then executes playback control of digital picture data based on that command set 1 (step D12). In this case, command set 1 has the same control contents as those for the consumer player.

If it is detected via the input device 14 that a user action for changing a command set has been taken (Yes in step D13), the CPU 11 checks if the command set is ready to be changed (step D14). The state the command set is ready to be changed is a state wherein the control waits for the next user action, e.g., a state wherein the picture is frozen. If the command set is not ready to be changed (No in step D13), the CPU 11 inhibits that change, and continues the current data playback.

If the command set is ready to be changed (Yes in step D14) and the new command set is recorded in the identical medium (Yes in step D15), the CPU 11 reads out command set 2 from the recording medium 16a and stores it in the work area 13a of the memory 13 (step D16). Then, the CPU 11 makes playback control of digital picture data on the basis of that command set 2 (step D17). In this case, command set 2 has control contents different from those for the consumer player.

On the other hand, if the new command set must be acquired from outside the medium (No in step D15), the CPU 11 acquires command set 3 from an external source (communication medium) and stores it in the work area 13a of the memory 13 (step D18). The CPU 11 then makes playback control of digital picture data on the basis of that command set 3 (step S19). In this case, command set 3 has control contents different from those for the consumer player, and is obtained via the communication medium. Note that the external source is not limited to the communication medium and includes an external storage device such as the HDD 18 or the like.

When a plurality of command sets are prepared in this manner, the playback control of digital picture data can be made in correspondence with each command set. Hence, playback control unique to the personal computer, which cannot be made by the consumer player, can be implemented.

In this embodiment, command set 1 is set as a default. However, a command set which was used in the previous data playback may be used initially.

In this embodiment, the command set is changed during data playback. Alternatively, the command set may be changed before data playback. In such case, a user action for changing the command set is taken upon data playback, and a new command set is acquired from the medium or external source in accordance with that user action to change the command set.

In the description of the first to third embodiments, digital picture data have been exemplified. However, the present invention is not limited to such specific data. For example, the processing described in each embodiment can be implemented for all kinds of multimedia data which can be continuously played back, such as AV data containing audio data, broadcast data sent from an external source, and the like, in addition to picture data.

As described in detail above, according to the present invention described in the first to third embodiments, when specific processing such as a game or the like is executed using multimedia data recorded on a recording medium such as a DVD-ROM or the like in addition to normal playback according to the predetermined format, a plurality of files that share the multimedia data are used, and playback control is made in accordance with these files, thus implementing efficient playback without recording different versions of identical multimedia data.

Since multimedia data recorded on a recording medium are managed in given time units, when a user action has been taken during data playback, processing corresponding to the user action defined by the playback time of multimedia data at that time can be executed.

Also, since multimedia data may be managed in units of playback volumes, when a user action has been taken during data playback, processing corresponding to the user action defined by the playback volume of the multimedia data at that time can be executed.

When control information different from that embedded in multimedia data is acquired from the recording medium or an external source (a communication medium, an external storage device such as an HDD, or the like), control different from normal playback can be implemented using identical multimedia data.

In this manner, when a recording medium such as a DVD-ROM which can also be used in a consumer player is used in the personal computer, a use method unique to the personal computer can be easily implemented without requiring any large modification such as recording of different versions of identical data.

<Fourth Embodiment>

The fourth embodiment of the present invention will be described below.

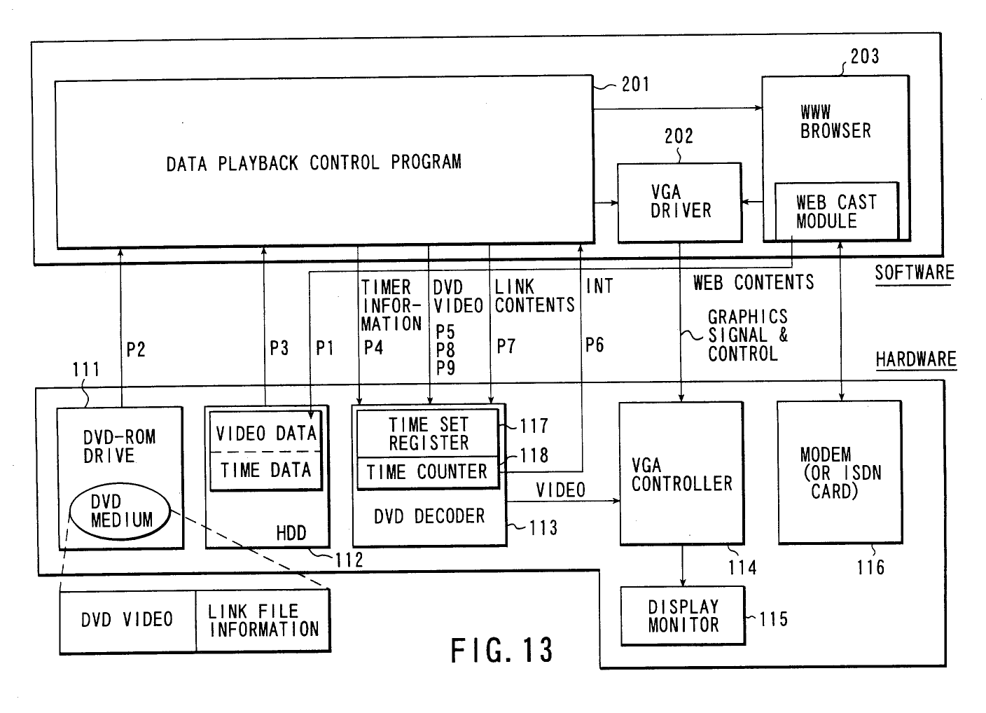

FIG. 13 shows the hardware and software basic arrangements of an image display apparatus according to the fourth embodiment of the present invention.

This image display apparatus is used as a digital video player, set top box, or personal computer, and has a function of displaying computer graphics, moving picture, and the like on a dedicated display monitor or home TV.

This image display apparatus includes, as hardware components required for playing back DVD video information, a DVD drive 111 for reading out information recorded on a DVD-ROM medium, an HDD 112 used as a rewritable local storage of the image display apparatus, a DVD decoder 113 for decoding DVD video information (video, sub-picture, and audio data) formed by an MPEG2 program stream read out from the DVD drive 111, a VGA controller 114 for controlling a display monitor 115, a communication device (ISDN card or modem) 116 for the Internet connection, and the like.

The DVD-ROM medium stores link file information (LINK FILE) for designating a link image to be displayed in place of the currently displayed DVD video data during playback of a DVD video title, in addition to a normal DVD video title consisting of navigation data and presentation data. The link file information (LINK FILE) is identification information for designating a link image (VIDEO DATA) which has been downloaded in advance onto a predetermined area of the HDD 112, and contains a file name, path name, and the like. Note that a URL for designating the digital contents at a predetermined Web site may be used as the link file information (LINK FILE).

The link image (VIDEO DATA) includes digital contents (moving picture, still picture, and the like) automatically distributed by, e.g., a push-style information service from an external source via the Internet. More specifically, a WWW browser 203 having a Web casting function automatically downloads new digital contents from a Web site managed by a DVD title producer or the like, and stores them on a dedicated cache area assured on the HDD 112. Such digital contents are provided as MPEG2 streams.

Each link image (VIDEO DATA) is appended with timer information (TIME DATA). The timer information (TIME DATA) designates the insertion & playback timing of the link image in a DVD title, and is given by a value indicating the time elapsed from the beginning of playback of the DVD title.

The DVD decoder 113 decodes MPEG2 streams of DVD video data, link image data, and the like to play them back. The decoded DVD video data and link image data are sent to the video input port of the VGA controller 114 as a video signal (VIDEO) in a digital YUV format.

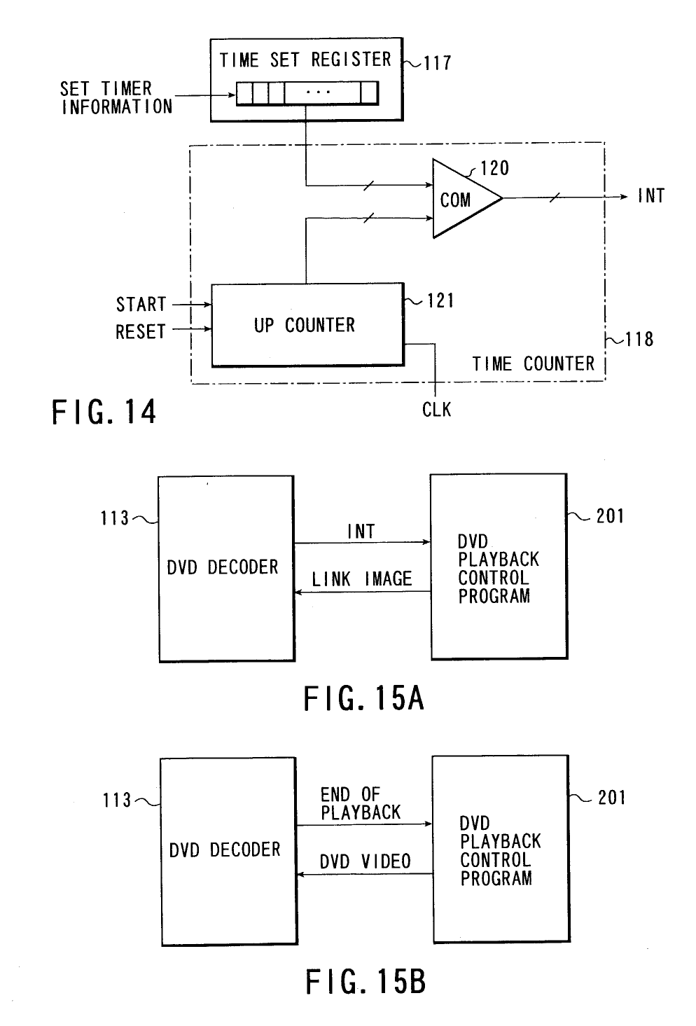

The DVD decoder 113 also has a time set register 117 and time counter 118. FIG. 14 shows an example of the hardware arrangement of these time set register 117 and time counter 118.

The time set register 117 is set with the timer information (TIME DATA) of a link image (VIDEO DATA) to be inserted and displayed in DVD video data as a link image insertion time.

In the time counter 118, an up counter 121 counts the time elapsed from the beginning of playback of DVD video data. When the time elapsed from the beginning of playback has matched the link image insertion time set in the time set register 117, the counter 118 generates an interrupt signal (INT) indicating it. More specifically, a comparator 112 compares the count value from the up counter 121 and the setting value of the time set register 117, and when the two values match each other, the interrupt signal (INT) is generated. The interrupt signal (INT) is used as a trigger for switching the currently played-back image from DVD video data to link image data.

Title playback on the DVD-ROM medium is controlled by a DVD playback control program 201 having an operation control function of the DVD drive 111 and DVD decoder 113. The DVD playback control program 201 is made up of a hardware driver group, an application program for playing back a title using such drivers, and the like.

The DVD playback control program 201 also has the following functions to switch the currently displayed image between DVD video data and link image data:

(1) a function of setting the link image information time information in the time set register 117;

(2) a function of switching image data to be transmitted to the DVD decoder 113 from DVD video data to link image data in response to an interrupt (INT) from the DVD decoder 113 (see FIG. 15A); and

(3) a function of returning image data to be transmitted to and played back by the DVD video decoder 113 to DVD video data in response to the end of playback of link image data (see FIG. 15B).

The WWW browser 203 is a WWW client which communicates with an external WWW server using a protocol called HTTP, receives Web contents from a Web site via the communication device 116, and displays them on the screen using the VGA controller 114. The WWW browser 203 has a Web casting function for a push-style information service. With this function, the latest Web contents are automatically distributed and are stored in the cache area on the HDD 112.

Operation for linking a moving picture or still picture transmitted as Web contents from the Internet to DVD video data on the DVD-ROM medium will be explained below.

In step P1, link image contents made up of link image data (VIDEO DATA) and time information (TIME DATA) are downloaded from an external source via the communication device 116 using the push technology of the Internet, and are saved on the cache area of the HDD 112.

In step P2, when the user starts the DVD playback control program 201 to play back certain DVD video data, the DVD playback control program 201 refers to link file information stored on the DVD medium that records the DVD video data to be played back, and checks if an image to be linked is set (link file information can designate a plurality of link images).

In step P3, the DVD playback control program 201 searches the cache area on the HDD 112 for a link image designated by the link file information.

In step P4, the DVD playback control program 201 sets time information (TIME DATA) corresponding to the link image data obtained by search in the time set register 117 of the DVD decoder 113 as a link image insertion time.

In step P5, the DVD playback control program 201 instructs the DVD decoder 113 to play back the DVD video data, and the DVD decoder 113 starts decoding for playing back the DVD video data read out from the DVD-ROM medium by the DVD playback control program 201.

In step P6, when decoding for playing back the DVD video data has been started, counting of the time counter 118 is also started to count the time elapsed from the beginning of playback of the DVD video data.

In step P7, if the count value of the time counter 118 has reached the value indicating the link image insertion time set in the time set register 117, the DVD decoder 113 pauses playback of the DVD video data and generates an interrupt signal (INT), thus informing the DVD playback control program 201 that the link image insertion time has been reached.

In step P8, upon reception of the interrupt signal (INT), the DVD playback control program 201 sends link image data stored in the HDD 112 to the DVD decoder 113 and instructs the decoder 113 to play it back.

In step P9, upon completion of transfer of the link image data to the DVD decoder 113, the DVD playback control program 201 sends the subsequent data of the paused DVD video data to the DVD decoder 113 to play them back.

In step P10, when the link file information designates a plurality of link images, a new link image insertion time is set in the time set register 117 before restart of playback of the subsequent DVD video data.

In step P11, steps P7 to P10 repeat themselves.

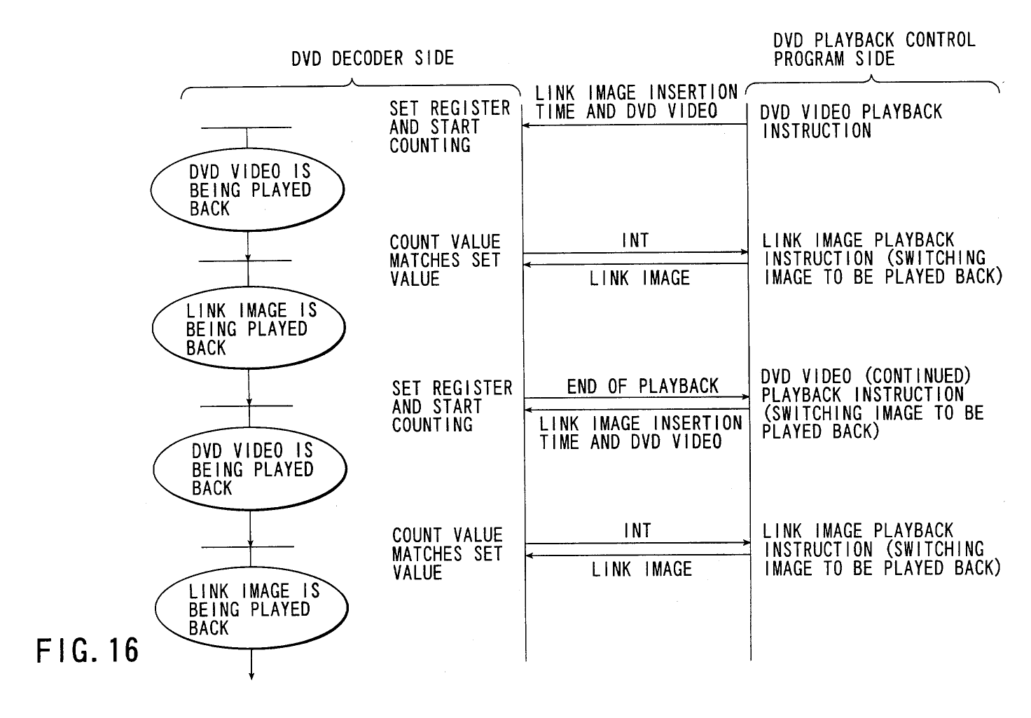

FIG. 16 is a chart showing the processes between the DVD decoder 113 and DVD playback control program 201, which correspond to steps P4 to P11 above.

To restate, in this embodiment, when the time elapsed from the beginning of playback of DVD video data made up of an MPEG2 stream has reached the link image insertion time set in advance, the image data to be played back is switched from the DVD video data to a link image designated by the link file information. In this way, since the time elapsed from the beginning of playback is used as a trigger for switching the image to be played back, the image to be played back can be switched to a link image at an arbitrary position independently of the position in the stream embedded with a picture branch command.

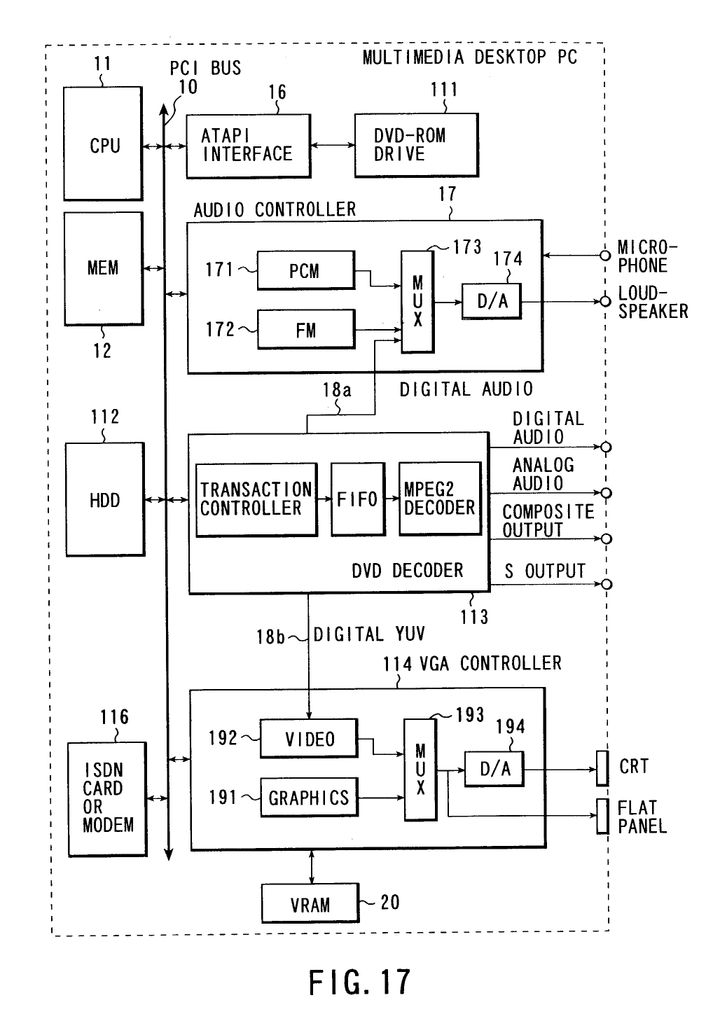

FIG. 17 shows the detailed system arrangement when the image display apparatus of this embodiment is implemented using a personal computer.

As shown in FIG. 17, this system includes a PCI bus 10, a CPU 11, a main memory (MEM) 12, a DVD interface 16 using an ATAPI or SCSI interface, and an audio controller 17, in addition to the above-mentioned DVD drive 111, HDD 112, DVD decoder 113, VGA controller 114, and communication device 116.

The DVD drive 111 reads out DVD video streams stored on a DVD medium at a transfer rate of 10.08 Mbps (maximum). The DVD drive 111 is comprised of a DVD medium as an optical disk, motor, pickup, pickup drive, servo controller, drive controller including an ECC circuit for error detection and correction, and the like. The motor, pickup, pickup drive, servo controller, and drive controller serve as a drive device for reading out data recorded on that DVD medium.

The DVD medium can record, e.g., a movie of approximately 135 min on one side. Presentation data that forms the movie information can contain main picture (video) data, sub-picture data for 32 channels (maximum), and audio data for 8 channels (maximum).

In the MPEG2 format, data encoded by MPEG2 can contain another encoded data, and these encoded data are processed as a single MPEG2 program stream.

Video encoding uses MPEG2, and sub-picture encoding and audio encoding respectively use runlength coding and DOLBY AC-3. In such case, encoded video, sub-picture, and audio data are processed as a single MPEG2 program stream.

Encoding in the MPEG2 format is variable rate encoding, and can vary the information volume to be recorded/played back per unit time. Hence, as a scene includes faster motions, the transfer rate of an MPEG stream that forms the corresponding frame group is increased, thus allowing high-quality moving picture playback.

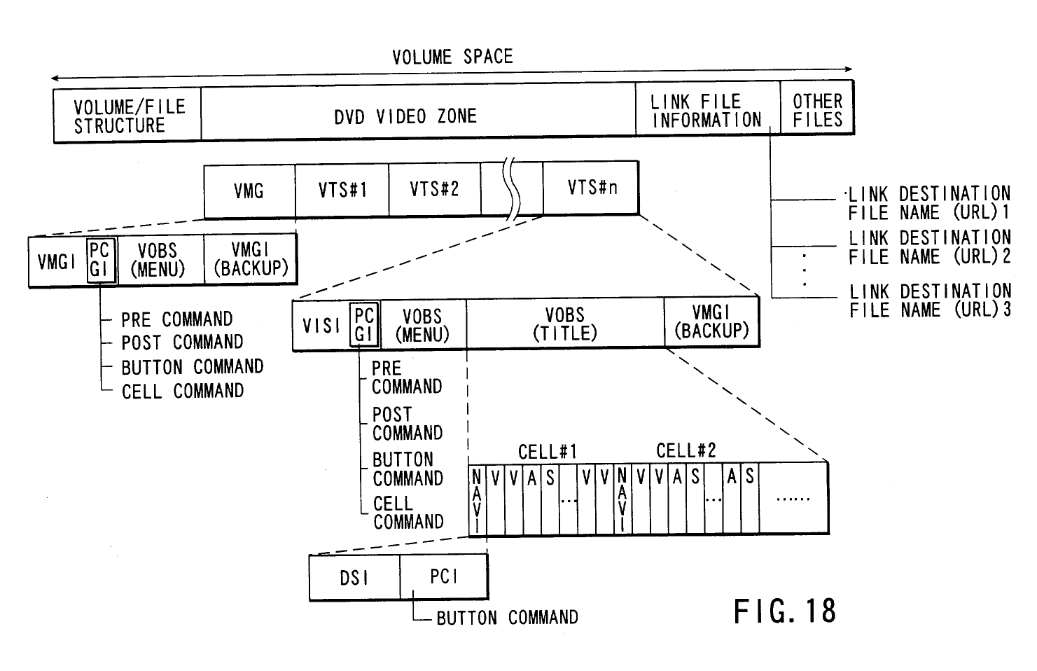

FIG. 18 shows an example of the recording format of DVD video information used in this embodiment. This recording format corresponds to the DVD video format.

As shown in FIG. 18, the volume space of a DVD-ROM medium is made up of a volume/file structure for managing the volume and files, a DVD video zone that forms DVD video information, and an area for files other than DVD video information. The other file area stores link file information according to the present invention. This link file information can be set with a plurality of link destination file names (path names such as URLs or the like) for designating images to be linked.

The DVD video zone consists of a video manager (VMG) and one or more DVD video title sets (VTS#1 to VTS#n).

The VMG contains video manager information (VMGI), a video object set (VOBS) for a menu, and backup video manager information (VMGI).

The VMGI is used as index information for all the DVD video title sets (VTS#1 to VTS#n) on the DVD medium, and contains search information, parental attribute information, and the like that pertain to each video title set (VTS). When the VMG contains the video object set (VOBS) for the menu, the VMGI also contains program chain information (PGCI) as playback or presentation control information for that menu. The PGCI indicates the playback order of a plurality of cells that form each video object (VOB), and the title producer can embed the above-mentioned navigation commands (pre-command, post command, button command, cell command) there.

The pre-command is a navigation command group executed before the beginning playback of a cell group (cells in a PGC), the playback order of which is defined by the PGCI, and is used for initialization before PGC playback. The post command is a navigation command group executed upon completion of playback of all the cells in the PGC, and is used in, e.g., branch processing to the next PGC to be played back. The cell command is a navigation command group executed at the time of completion of playback of a corresponding cell in the PGC, and is used for, e.g., repetitively playing back a specific cell. The button command is a navigation command group executed when a button as a selection item on a menu window is determined by user operation, and is used for executing, e.g., a menu item.

Each video title set (VTS) is made up of video title set information (VTSI), a video object set (VOBS) for a menu, a video object set (VOBS) that forms a title, and backup video title set information (VTSI).

The VTSI is playback control information of a menu and title in that VTS, and contains search information of the title, and program chain information (PGCI) for managing the cell playback order in that menu and title. This PGCI is also embedded with the above-mentioned navigation commands (pre-command, post command, button command, cell command).

The video object set (VOBS) that forms the title includes a large number of video objects (cell #1, cell #2, . . . ) called cells. Each cell consists of a large number of video object units, and contains a navigation pack (NAVI) at its head position. That is, a certain navigation pack to the next navigation pack form one cell (video object). These navigation packs are contained in units of video data for one GOP or two GOPs (0.5 sec to 1 sec), as described above. Each navigation pack is management information for controlling playback of the corresponding video object, and is made up of a disk search information (DSI) pack and presentation control information (PCI) pack. The DSI pack is used as, e.g., search information of the playback start address upon special playback such as fastforwarding, rewinding, and the like. The PCI pack is used for switching angle in a multiangle playback mode, and displaying highlight information for executing a navigation command (button command) in accordance with a user's instruction.

One cell forms information for 15 frames required for playing back a moving picture for a predetermined period of time, e.g., 0.5 sec to 1 sec, and is made up in units of GOPs (Groups of picture) of the MPEG2 program stream, as described above. Each cell records multiplexed video (V), sub-picture (S), and audio (A) packs. These video (V), sub-picture (S), and audio (A) packs are data units of encoded video, sub-picture, and audio data. The data size of each pack is fixed, but the number of packs that can be contained in a single cell is variable. Hence, as a scene includes faster motions, the corresponding cell contains a larger number of video packs.

In the aforementioned format, the VMGI, VTSI, PGCI, PCI, and DSI make up navigation data, and the video packs for the menu and title, sub-picture packs, and audio packs make up presentation data.

Referring back to FIG. 17, the individual units of this system will be explained.

The CPU 11 controls the operation of the entire system, and executes an operating system stored in the system memory (MEM) 12, and an application program to be executed. A DVD video title recorded on a DVD medium begins to be played back when the CPU 11 executes the DVD playback control program 201.

The DVD interface 16 is a peripheral interface for connecting a peripheral device such as an HDD, CD-ROM drive, or the like to the PCI bus 10, and performs data transfer with the DVD drive 111 in this embodiment.

The audio controller 17 performs I/O control of sound data under the control of the CPU 11, and includes a PCM sound source 171, FM sound source 172, multiplexer 173, and D/A converter 174 to output sound data. The multiplexer 173 receives the outputs from the PCM and FM sound sources 171 and 172, and digital audio data transferred from the DVD decoder 113, and selects one of these inputs. Note that a function corresponding to the D/A converter in this audio controller 17 is also provided to the DVD decoder 113, and an analog audio signal can be directly output without using the audio controller 17.

Digital audio data is obtained by decoding audio data read out from the DVD drive 111. The digital audio data is transferred from the DVD decoder 113 to the audio decoder 17 via an audio bus 18a without using the PCI bus 10. Hence, high-speed transfer of digital audio data can be implemented without influencing any performance of the computer system.

The DVD decoder 113 reads out an MPEG2 program stream from the DVD drive 111 via the memory 12 or directly under the control of the CPU 111, segments it into video, sub-picture, and audio packets, decodes them, and then synchronously outputs the decoded data. As shown in FIG. 17, the DVD decoder 113 includes a transaction controller, FIFO buffer, and MPEG2 decoder. The transaction controller makes the DVD decoder 113 operate as a bus master (initiator) that issues a transaction onto the PCI bus 10, and executes a bus cycle for reading an MPEG2 program stream from the memory 12 or DVD-ROM drive 111. This MPEG2 program stream is sent to the MPEG2 decoder via the FIFO buffer, and segmentation of the stream into video, sub-picture, and audio packets and decoding of these packets are done by the decoder.

The decoded audio data is transferred to the audio controller 17 via an audio bus 18a as digital audio data, as described above, or is directly output to an external DSP or the like. The decoded video and sub-picture data are synthesized, and the synthesized data is sent to the video input port of the VGA controller 114 as digital YUV data. In this case, the digital YUV data is transferred from the DVD decoder 113 to the VGA controller 114 via a video bus 18b without using the PCI bus 10. Hence, the digital YUV data can also be transferred at high speed without influencing any performance of the computer system.

As the video bus 18b, a VAFC (VESA Advanced Feature Connector) or VM-Channel (VESA Media Channel) complying with VESA, S3 LBP interface, ZV port, or the like can be used.

The VGA controller 114 controls a CRT display or LCD used as a display monitor of this system under the control of the CPU 111, and supports moving picture display in addition to text & graphics display complying with the VGA standards. The VGA controller 114 is composed of a graphics display control circuit 191, video display control circuit 192, multiplexer 193, D/A converter 194, and the like, as shown in FIG. 17.

The graphics display control circuit 191 is a VGA compatible graphics controller, which converts VGA graphics data rendered on a video memory (VRAM) 20 into RGB video data, and outputs them. The video display control circuit 192 has a video buffer for storing digital YUV data, a YUV-RGB converter for converting the YUV data stored in the buffer into RGB video data, and the like.

The multiplexer 193 selects one of the output data from the graphics display control circuit 191 and video display control circuit 192, or synthesizes video data from the video display control circuit 192 on VGA graphics data from the graphics display control circuit 191, and sends the synthesized data to the LCD and D/A converter 194. The D/A converter 194 converts the video data from the multiplexer 193 into analog RGB signals, and outputs them to the CRT display.

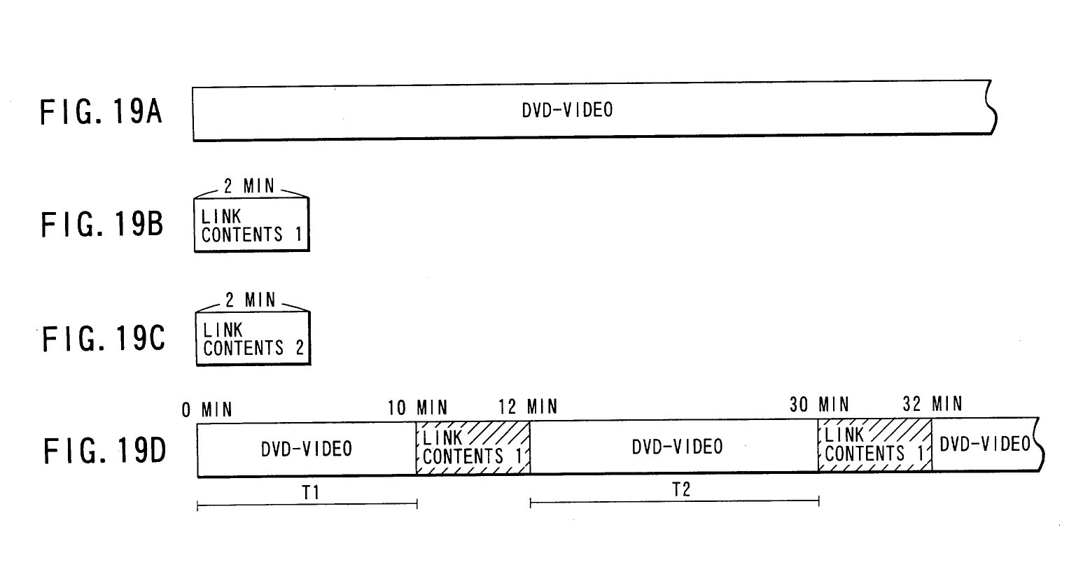

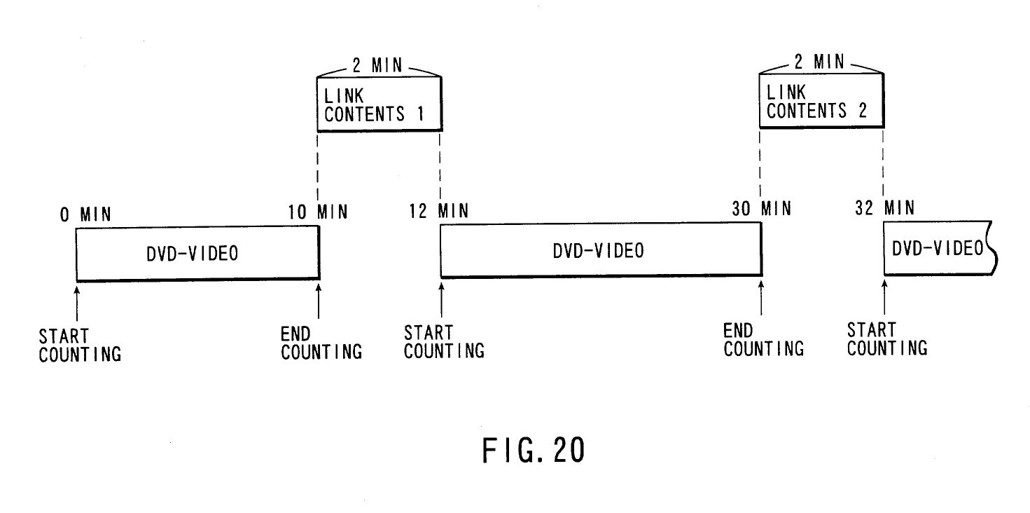

Image switching between DVD video data and link image data will be explained below with reference to FIGS. 19A to 19D and FIG. 20.

Assume that two link images, i.e., a link image (link contents 1) shown in FIG. 19B and a link image (link contents 2) shown in FIG. 19C are inserted into a DVD video stream shown in FIG. 19A.

Also, assume that each of link contents 1 and 2 consists of a picture source having a playback time of 2 min, a link image insertion time T1 corresponding to link contents 1 is set at 10 min, and a link image insertion time T2 corresponding to link contents 2 is set at 18 min. In such case, as shown in FIG. 19D, when 10 min have elapsed from the beginning of playback of DVD video data, the image to be played back is switched to link contents 1, and link contents 1are then played back. Upon completion of 2-min playback of link contents 1, the subsequent DVD video data are played back again. When 18 min designated by the link image insertion time T2 have elapsed from the restart of playback, the image to be played back is switched to link contents 2, and link contents 2 are played back. Upon completion of 2-min playback of link contents 2, the subsequent DVD video data are played back again.

More specifically, as shown in FIG. 20, when 10 min have elapsed from the beginning of counting, the image to be played back is switched from DVD video data to link contents 1, and link contents 1 are played back for 2 min. Upon completion of playback of link contents 1, the image to be played back is switched from link contents 1to DVD video data. After the counter is reset, when 18 min have elapsed from the beginning of counting, the image to be played back is switched from DVD video data to link contents 2, and link contents 2 are played back for 2 min. Upon completion of playback of link contents 2, the image to be played back is switched from link contents 2 to DVD video data.

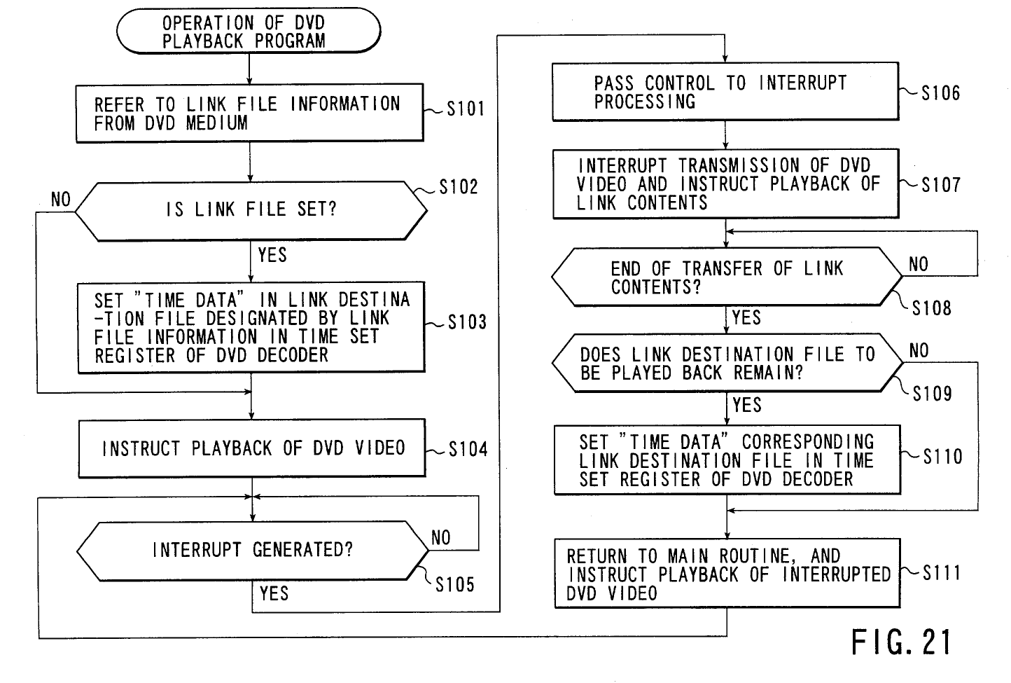

The processing sequence of the DVD playback control program 201 will be explained below with reference to the flow chart in FIG. 21.

When the user starts the DVD playback control program 201 to play back certain DVD video data, the DVD playback control program 201 refers to link file information stored on the DVD medium that records the DVD video data to be played back prior to the beginning of playback of the DVD video data (step S101), and checks if an image to be linked is set (step S102).

If the link file information designates the image to be linked, the DVD playback control program 201 searches the cache area on the HDD 112 for the link image designated by the link file information, and sets time information (TIME DATA) corresponding to the link image obtained by search in the time set register 117 of the DVD decoder 113 as a link image insertion time (step S103).

Subsequently, the DVD playback control program 201 sends DVD video data read out from the DVD-ROM medium to the DVD decoder 113 and instructs it to play them back (step S104).

Upon generation of an interrupt by the DVD decoder 113 (step S105), the DVD playback control program 201 passes control to interrupt processing (step S106).

In this interrupt processing, the DVD playback control program 201 interrupts transmission of DVD video data, sends the link contents stored in the HDD 112 to the DVD decoder 113, and instructs it to play them back (step S107).

Upon completion of transfer of the link contents to the DVD decoder 113 (step S108), it is checked if the link contents designated by the link file information include those which are not yet played back (step S109).

If link contents to be played back remain, time information (TIME DATA) corresponding to the next link contents to be inserted is set in the time set register 117 of the DVD decoder 113 as a link image insertion time (step S110).

The control returns to the main routine, and the DVD playback control program 201 sends the subsequent data of the DVD video data, playback of which was interrupted, to the DVD decoder 113 and instructs it to play them back (step S111). The program 201 then repeats the processing in step S105 and the subsequent steps.

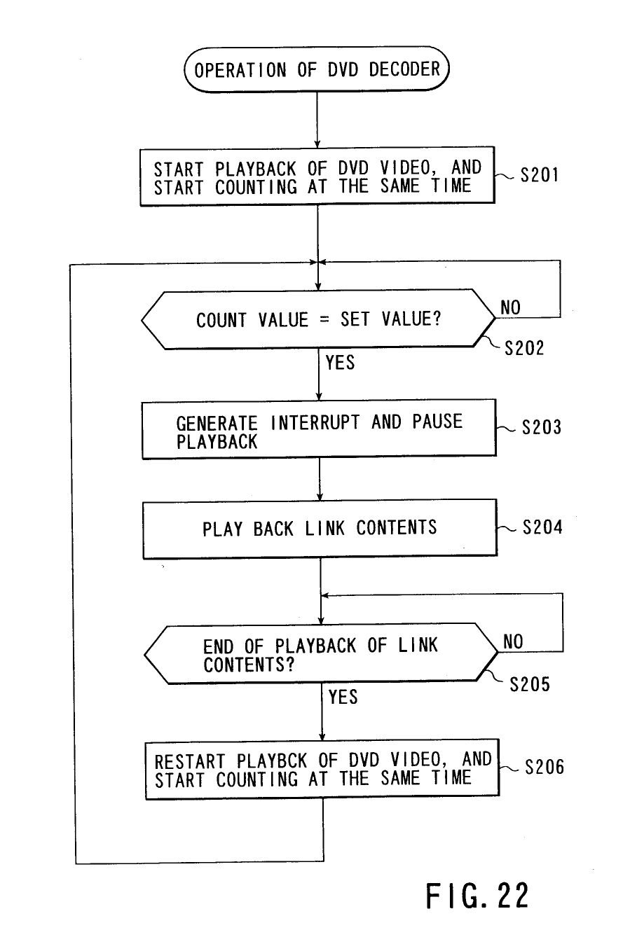

The processing sequence of the DVD decoder 113 will be explained below with reference to the flow chart in FIG. 22.

Upon reception of a DVD video playback instruction from the DVD playback control program 201, the DVD decoder 113 begins to play back DVD video data read out from the DVD-ROM medium by the DVD playback control program 201, and also starts counting of the time counter 118 (step S201).

If the count value of the time counter 118 has reached the value indicated by the link image insertion time set in the time set register 117 (step S202), the DVD decoder 113 temporarily pauses playback of DVD video data, and generates an interrupt signal (INT) to inform the DVD playback control program 201 that the link image insertion time has been reached (step S203). The DVD decoder 113 receives the link contents stored in the HDD 112 from the DVD playback control program 201, and plays them back (step S204).

Upon completion of playback of the link contents (step S205), the DVD decoder 113 restarts playback of the paused DVD video data, and also starts counting of the time counter 118 (step S206), then repeating the processing in step S202 and the subsequent steps.

Note that this embodiment has exemplified switching display between DVD video data and contents downloaded in advance on the HDD by the push technology. Also, digital contents such as a digital broadcast program provided by satellite broadcast or CATV can be played back while being linked with DVD video data. In addition, link image data may be recorded on a DVD medium different from that records the DVD video data, or a CD-ROM medium, and the recording media may be distributed. Furthermore, upon generation of an interrupt from the DVD decoder 113, the corresponding link image may be acquired from a Web site using the WWW browser 203.

As the link image, a still picture in another file format, which does not require decoding by the DVD decoder 113 may be used in addition to moving picture data defined by an MPEG2 stream. In such case, the DVD playback control program 201 sends that still picture to the VGA controller 114 via a VGA driver 202 as graphics data. This graphics data is rendered on the VRAM 20 via the PCI bus interface of the VGA controller 114, and is then displayed on the screen.

Furthermore, the DVD playback control program having the sequence shown in FIG. 21 can be distributed via computer-readable recording media such as CD-ROMs, and the like.

To recapitulate, according to the present invention described in the fourth embodiment, switching of the image to be played back at an arbitrary playback position in a moving picture stream that forms a title, link to an arbitrary picture source, and automatic updating of a link destination picture source using the push technology can be implemented without changing any title structure of DVD video data and the like, and title playback with a higher degree of freedom can be made.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A data playback control apparatus for playing back multimedia data recorded on a recording medium on the basis of the multimedia data and control information for playback control embedded in the multimedia data, comprising:
a management table for managing a first file that defines physical locations of the multimedia data and control information, and a second file that defines physical locations of at least part of the multimedia data; and
control means for controlling playback of the multimedia data on the basis of one of the first and second files stored in said management table.

2. An apparatus according to claim 1, wherein said management table is located at a predetermined position on said recording medium.

3. An apparatus according to claim 1, wherein said control means searches said management table for the first file in accordance with an external instruction, and executes playback using the multimedia data and control information whose physical locations are defined by the file obtained by search.

4. An apparatus according to claim 1, wherein said control means searches said management table for the second file in accordance with an external instruction, and executes specific playback using part of the multimedia data whose physical locations are defined by the file obtained by search.

5. A recording medium for storing computer-readable information, said information comprising:
multimedia data embedded with control information for playback control in predetermined playback units; and
a management table for managing a first file that defines physical locations of the multimedia data and control information, and a second file that defines physical locations of at least part of the multimedia data.

6. A data playback control method for use in a data playback control apparatus for playing back multimedia data recorded on a recording medium on the basis of the multimedia data and control information for playback control embedded in the multimedia data, comprising the steps of:
preparing a management table for managing a first file that defines physical locations of the multimedia data and control information, and a second file that defines physical locations of at least part of the multimedia data; and
executing playback of the multimedia data on the basis of one of the first and second files stored in said management table.

7. A data playback control apparatus for playing back multimedia data recorded on a recording medium on the basis of the multimedia data and control information for playback control embedded in the multimedia data, comprising:
an information table defining processing corresponding to user actions in units of playback times of the multimedia data;
user action detection means for detecting presence/absence of a user action during playback of the multimedia data; and
control means for looking up said information table when said user action detection means detects that a user action has been taken, and executing processing corresponding to the user action defined by the playback time of the multimedia data at that time.

8. An apparatus according to claim 7, wherein said information table is stored at a predetermined position on said recording medium.

9. An apparatus according to claim 7, further comprising means for describing contents defined by said information table in a script format.

10. An apparatus according to claim 7, further comprising means for acquiring said information table from an external source.

11. An apparatus according to claim 7, wherein said control means executes processing for acquiring Internet information pertaining to a scene which is being played back, on the basis of the user action defined by the playback time of the multimedia data.

12. A data playback control apparatus for playing back multimedia data recorded on a recording medium on the basis of the multimedia data and control information for playback control embedded in the multimedia data, comprising:
an information table defining processing corresponding to user actions in units of playback volumes of the multimedia data;
user action detection means for detecting presence/absence of a user action during playback of the multimedia data; and
control means for looking up said information table when said user action detection means detects that a user action has been taken, and executing processing corresponding to the user action defined by the playback volume of the multimedia data at that time.

13. An apparatus according to claim 12, wherein said information table is stored at a predetermined position on said recording medium.

14. An apparatus according to claim 12, further comprising means for describing contents defined by said information table in a script format.

15. An apparatus according to claim 12, further comprising means for acquiring said information table from an external source.

16. An apparatus according to claim 12, wherein said control means executes processing for acquiring Internet information pertaining to a scene which is being played back, on the basis of the user action defined by the playback volume of the multimedia data.

17. A recording medium for storing computer-readable information, said information comprising:
multimedia data embedded with control information for playback control in predetermined playback units; and
an information table defining processing corresponding to user actions in playback time units of the multimedia data.

18. A recording medium for storing computer-readable information, said information comprising:
multimedia data embedded with control information for playback control in predetermined playback units; and
an information table defining processing corresponding to user actions in units of playback volumes of the multimedia data.

19. A data playback control method for use in a data playback control apparatus for playing back multimedia data recorded on a recording medium on the basis of the multimedia data and control information for playback control embedded in the multimedia data, comprising the steps of:
preparing an information table defining processing corresponding to user actions in playback time units of the multimedia data;
detecting presence/absence of a user action during playback of the multimedia data; and
looking up said information table when it is detected that a user action has been taken, and executing processing corresponding to the user action defined by the playback time of the multimedia data at that time.

20. A data playback control method for use in a data playback control apparatus for playing back multimedia data recorded on a recording medium on the basis of the multimedia data and control information for playback control embedded in the multimedia data, comprising the steps of:
preparing an information table defining processing corresponding to user actions in units of playback volumes of the multimedia data;
detecting presence/absence of a user action during playback of the multimedia data; and
looking up said information table when it is detected that a user action has been taken, and executing processing corresponding to the user action defined by the playback volume of the multimedia data at that time.

21. A data playback control apparatus for playing back multimedia data stored in a recording medium on the basis of the multimedia data, and first control information for playback control embedded in the multimedia data, comprising:
control information acquisition means for acquiring second control information for controlling at least part of the multimedia data in addition to the first control information embedded in the multimedia data; and
control means for performing playback control of the multimedia data on the basis of the second control information acquired by said control information acquisition means.

22. An apparatus according to claim 21, wherein the second control information is stored at a predetermined position on said recording medium in a file format, and
said control information acquisition means acquires the second control information from said recording medium.

23. An apparatus according to claim 21, wherein said control information acquisition means acquires the second control information from an external source.

24. An apparatus according to claim 21, wherein a plurality of pieces of second control information equivalent to the second control information are prepared, and
said control information acquisition means selectively acquires the plurality of pieces of second control information in accordance with an external instruction.

25. A recording medium for storing computer-readable information, said information comprising:
multimedia data embedded with first control information for playback control in predetermined playback units; and
second control information for controlling at least part of said multimedia data in addition to the first control information embedded in said multimedia data.

26. A data playback control method for use in a data playback control apparatus for playing back multimedia data stored in a recording medium on the basis of the multimedia data, and first control information for playback control embedded in the multimedia data, comprising the steps of:
acquiring second control information for controlling at least part of the multimedia data in addition to the first control information embedded in the multimedia data; and
performing playback control of the multimedia data on the basis of the second control information.

27. An image display apparatus comprising:
playback means for reading out and playing back a moving picture stream from a recording medium that stores link information designating a link image to be inserted into the moving picture stream; and
playback image switching means for counting a time elapsed from the beginning of playback of the moving picture stream, and switching an image to be played back from the moving picture stream to the link image designated by the link information when the time elapsed from the beginning of playback has reached a link image insertion time which is set in advance.

28. An apparatus according to claim 27, wherein the link image is recorded on a second recording medium different from said recording medium that records the moving picture stream, and
the image to be played back is switched between the different recording media.

29. An apparatus according to claim 27, wherein time information indicating an insertion time of the link image is defined in the link image, and
the image to be played back is switched from the moving picture stream to the link image when the time elapsed from the beginning of playback of the moving picture stream has reached the link image insertion time indicated by the time information.

30. An apparatus according to claim 27, wherein the link image is digital contents which are automatically distributed by a push-style information service from an external source via a network, and are written in a rewritable local storage of said image display apparatus, and
said playback image switching means searches the digital contents in said local storage for the link image designated by the link information, and transmits the link image obtained by search to said playback means to play back the link image.

31. An image display apparatus comprising:
playback means for playing back a moving picture stream;
means for counting a time elapsed from the beginning of playback of the moving picture stream, and generating an interrupt signal when the time elapsed from the beginning of playback of the moving picture stream has reached a link image insertion time which is set in advance; and
moving picture playback control program means for controlling said playback means to switch an image to be played back from the moving picture stream to a link image other than the moving picture stream in response to the interrupt signal.

32. An apparatus according to claim 31, wherein the link image is recorded on a second recording medium different from said recording medium that records the moving picture stream, and
the image to be played back is switched between the different recording media.

33. An apparatus according to claim 31, wherein time information indicating an insertion time of the link image is defined in the link image, and
the image to be played back is switched from the moving picture stream to the link image when the time elapsed from the beginning of playback of the moving picture stream has reached the link image insertion time indicated by the time information.

34. An apparatus according to claim 31, wherein the link image is digital contents which are automatically distributed by a push-style information service from an external source via a network, and are written in a rewritable local storage of said image display apparatus, and
said moving picture playback control program means searches the digital contents in said local storage for the link image designated by the link information, and transmits the link image obtained by search to said playback means to play back the link image.

35. An image switching display method applied to an image display apparatus for reading out and playing back a moving picture stream stored in a recording medium, comprising the steps of:
holding a predetermined elapsed time from the beginning of playback of the moving picture stream as a link image insertion time; and
switching an image to be played back from the moving picture stream to a link image other than the moving picture stream when a time elapsed from the beginning of playback of the moving picture stream has reached the link image insertion time.

36. A method according to claim 35, wherein the link image is stored in a second recording medium different from said recording medium that records the moving picture stream together with time information indicating the link image insertion time, and
the time information in the link image is read prior to the beginning of playback of the moving picture stream, and the link image insertion time is held on the basis of the read time information.

37. A method according to claim 35, wherein the link image is digital contents which are automatically distributed by a push-style information service from an external source via a network, and are written in a rewritable local storage of said image display apparatus.
